(19) United States
(12) Patent Application Publication
(10) Pub. No.: US 2011/0102117 A1
(43) Pub. Date: May 5, 2011

(54) PROCESS FOR THE PRODUCTION OF MACROSCOPIC NANOSTRUCTURED PERMANENT MAGNETS WITH HIGH DENSITY OF MAGNETIC ENERGY AND CORRESPONDING MAGNETS

(76) Inventors: Alessandro Chiolerio, Torino (IT); Paolo Allia, Torino (IT)

(21) Appl. No.: 12/997,798

(22) PCT Filed: Jun. 11, 2009
(86) PCT No.: PCT/IB09/52502

§ 371 Date: Dec. 13, 2010

(30) Foreign Application Priority Data
Jun. 13, 2008 (IT) TO2008A000462

(51) Int. Cl. B05C 5/00; B05D 5/12; B32B 37/10; B28B 19/00; H01F 7/02

(52) U.S. Cl. 335/302; 427/130; 156/182; 118/313; 156/390

(57) ABSTRACT

Process for the production of permanent magnets, of the kind that allows the production of nanostructured alloys (containing a volume fraction lower than 10% of the rare-earth-based stoichiometric compound) in the form of a multilayered material, comprising a stoichiometric hard phase containing rare earths localized in a series of stacked layers intercalated by soft ferromagnetic layers. According to the invention, comprises producing nanostructured elements along a respective vertical axis by means of an inkjet printing system and the parallelization of such productive phase, by means of matrices of productive elements.

The present invention refers to the area of systems and processes for the production of permanent magnets, in particular nanostructured macroscopic or thin films having a high magnetic energy density for applications to high-efficiency electrical motors and generators.

The research on permanent magnets is the subject of generalized efforts on the global scale, enhanced by the need of producing miniaturized electronic devices, electrical current generators and dc motors.

The magnetic properties required for these materials can be summarized in a high coercivity and a high remanent magnetization, both implying a large area of the hysteresis loop proportional to the magnetic energy density, in turn defined as the product of the magnetic induction times the magnitude of the magnetic field (B×H), and usually measured in MGOe or in J/m³ (1 MGOe≈7742 J/m³). A permanent magnet with a high B×H product whose working point is at an intermediate position between coercivity and remanence (depending on shape and boundary conditions) is the source of very strong magnetic fields and is hardly influenced by any external magnetic field; therefore, it can induce strong electromotive forces and be an optimum choice for both motor applications and electrical generators. Usually, the most suitable materials contain alloys of rare earth metals and transition metals (Sm₂Co₁₇, SmCo₅, Nd₂Fe₁₄B, Sm₂ (CoFe)₁₇, Sm₂Fe₁₇N₃, etc.), where the first element's crystal structure brings about a high magneto-crystalline anisotropy (hard phase) while the transition metal contributes to the overall system's magnetic moment (soft phase).

In order to get cheaper high-performance permanent magnets, the content of rare earths is slightly reduced, preferably choosing an iron-neodymium alloy instead of a cobalt-samarium one, with the additional advantage of a better workability.

According to recent developments of the physics of magnetism, a specific mechanism, i.e. dipolar coupling, has been considered as a possible starting point for producing materials having very high energy product B×H (>1 MGOe) with a reduced rare earth metal concentration. These concepts have been described, for instance, in the work by Lee, Bauser, Higgins, Chen and Liu “Bulk anisotropic composite rare earth magnets”, J. Appl. Phys, 99, 08B516 (2006). Recent numerical simulations show that in principle the same performances could be achieved using nanostructured alloys containing less than 10% of stoichiometric rare earth-based compound; see for instance Skomsky and Coey “Giant energy product in nanostructured two-phase magnet”, Phys. Rev. B, 48, 21 (1993). According to these studies, the optimum structure to satisfy the requirements to get a good performance is represented by a lamellar nanostructured material, where the stoichiometric hard phase containing rare earth metals consists of a set of stacked layers with typical thickness of about ten nanometers, separated by other layers of a soft ferromagnetic material with thickness of about 100 nanometers. However, the available process techniques have not succeeded so far in fabricating macroscopic manufactures constituted of nanostructured multilayered composites on the industrial scale.

The main production methods for permanent magnets comprised of biphasic materials containing a rare-earth based, hard ferromagnetic phase and a soft ferromagnetic phase based on Fe, Co, Ni can be classified as powder metallurgy processes. In this case, uniaxial cold pressing is performed, followed by either sintering, or uniaxial hot pressing or isostatic hot pressing. As a consequence, the microcrystalline structure of biphasic alloys obtained in this way is not sufficient to reach the theoretical performances estimated in the literature. Such a major disadvantage is attributed to a loose control on the nanostructure of crystals obtained through these techniques and to the shape typically assumed by the inclusions of the rare-earth based alloys (which are spherical or cylindrical, i.e., definitely far from behaving as bona-fide lamellae).

The aim of the present invention is to obtain a process for manufacturing nanostructured, multilayered permanent magnets (both as thin films and macroscopic pieces) characterized by a high magnetic energy density, and allowing an excellently performing and inexpensive (because of the lesser content of rare earths) magnetic material to be obtained.

In view of reaching such aim, the present invention regards a process for producing permanent magnets of the type which implies depositing alloys as multilayered nanostructured material, such operation of depositing implying to deposit a first set of stacked layers of a hard ferromagnetic material, intercalating to said first set of stacked layers a second set of layers of soft magnetic material, which comprises providing said hard and/or soft ferromagnetic material as a solution of magnetic nanoparticles, bringing said solution of magnetic nanoparticles to means for spraying liquid micro-jets, spraying said solution to deposit said first set of layers and/or said second set of layers. The invention also regards a system for producing macroscopic permanent magnets, as well as a corresponding permanent magnet. According to a preferred characteristic of the invention, said means for spraying liquid micro-jets include printing inkjet heads. According to another preferred feature, includes using means for spraying liquid micro-jets including at least two nozzles and that the solution containing nanoparticles of a hard magnetic material is sent to one of the nozzles, the solution containing nanoparticles of a soft magnetic material being sent to the other nozzle.

By virtue of the above mentioned features, the process according to the invention presents the advantage of a complete control of the biphasic material at the multilayered nanostructure level, allowing the volume fraction of rare-earth based, hard alloys to be limited to the theoretically expected values. In addition, adopting micro-jet spraying allows the surface area of the produced magnet to be covered with a deposition detail of at least one tenth of a millimetre, if needed.

Additional features and advantages of the invention will result from the following description, with reference to the attached drawings given as mere non-limitative examples, where:

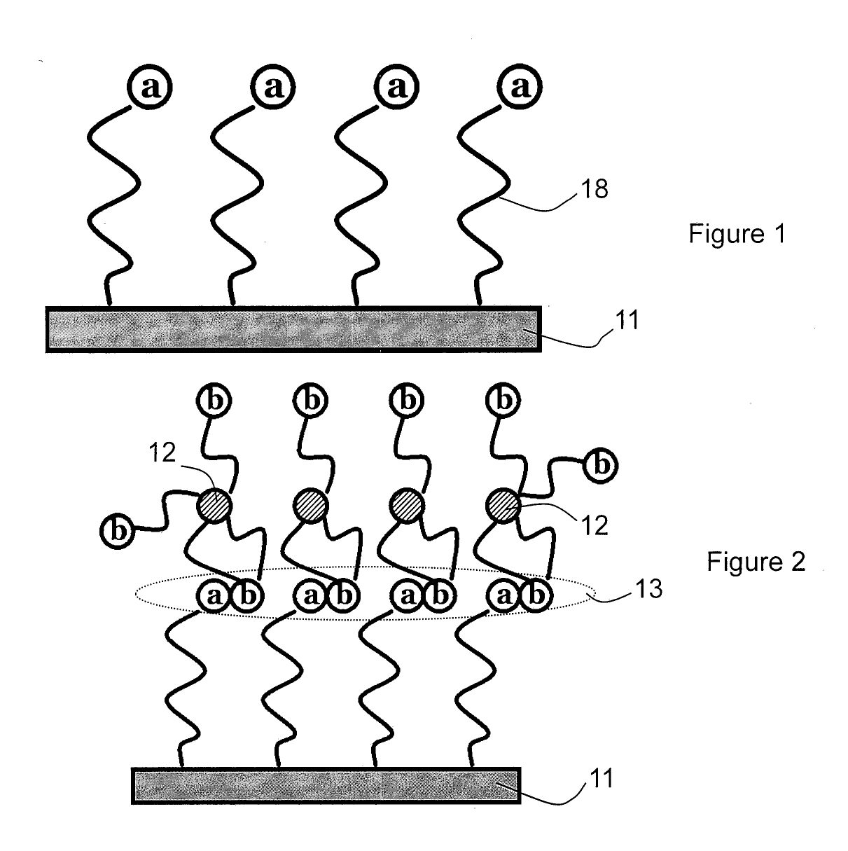

FIG. 1 schematically shows a first process step according to the invention;

FIG. 2 schematically shows a second process step according to the invention;

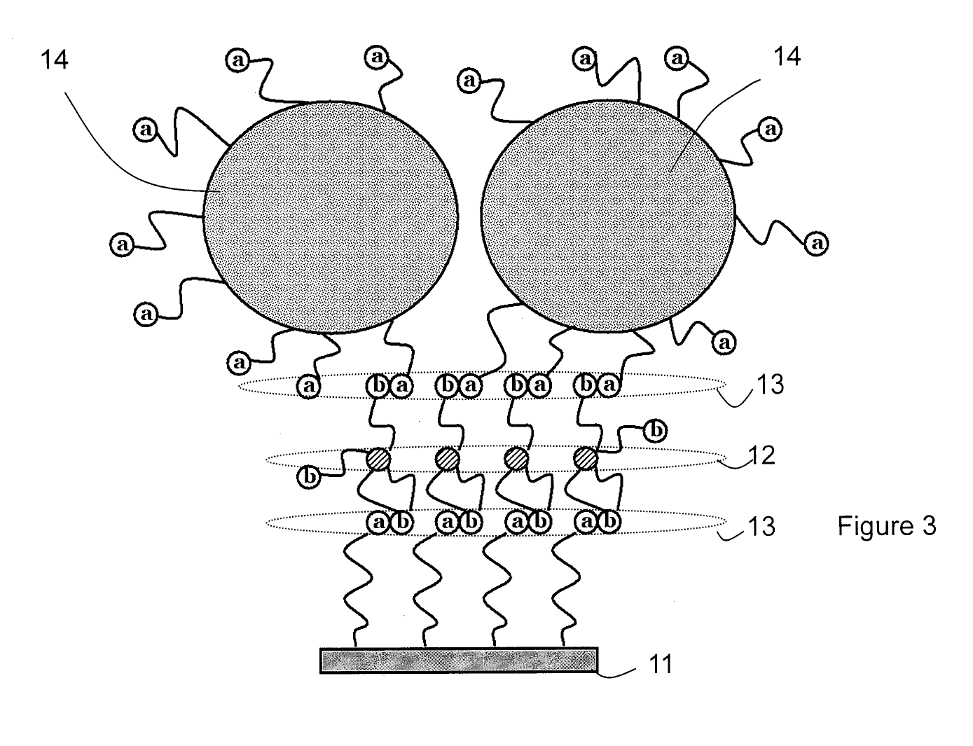

FIG. 3 schematically shows a third process step according to the invention;

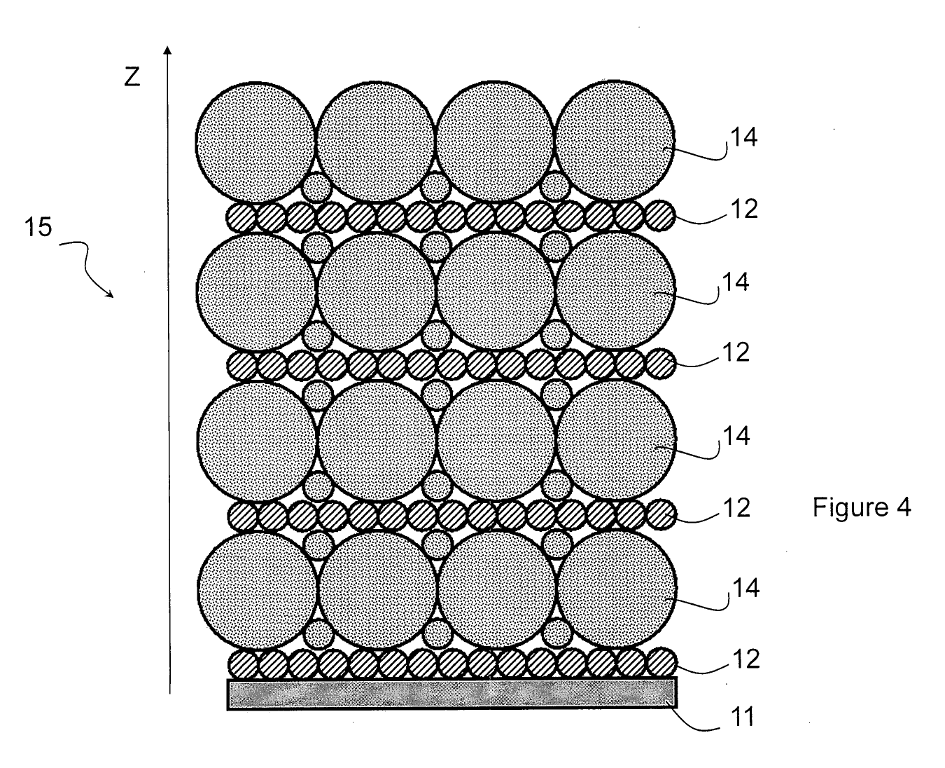

FIG. 4 schematically shows a fourth process step according to the invention;

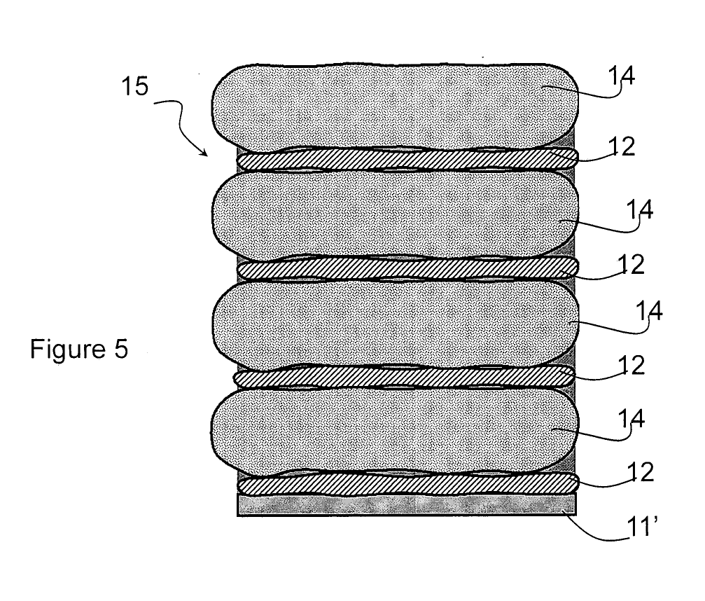

FIG. 5 schematically shows a fifth process step according to the invention;

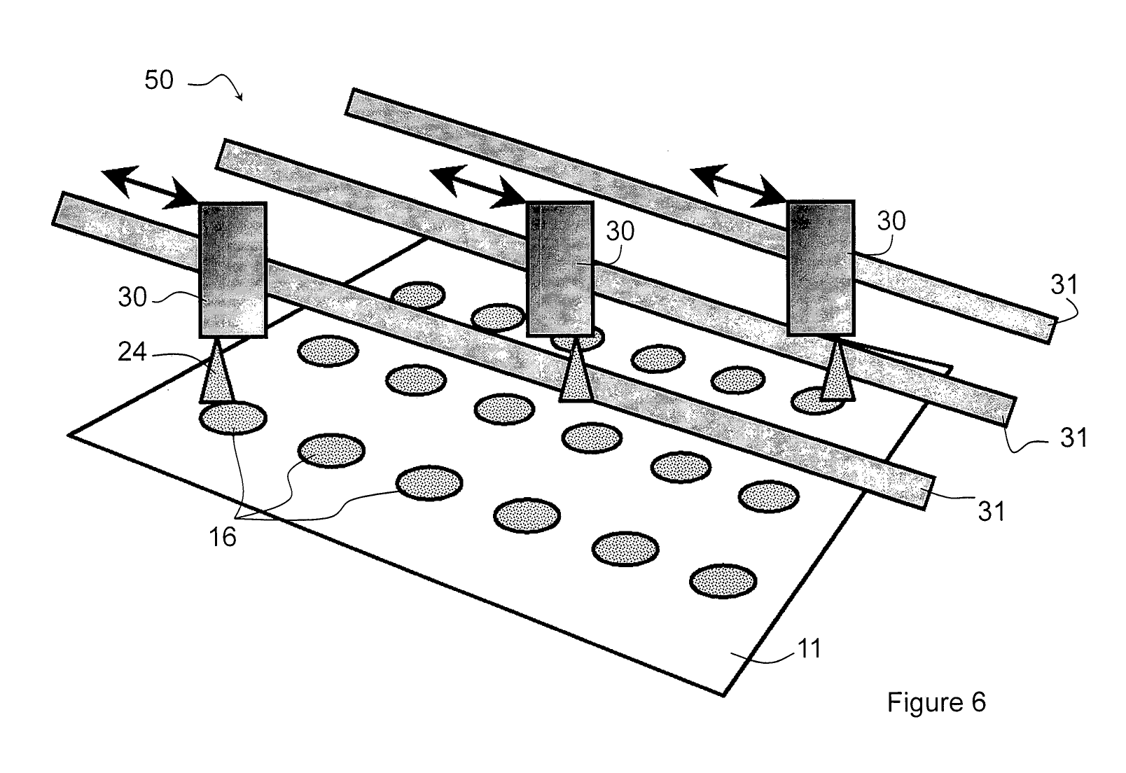

FIG. 6 schematically shows a sixth process step according to the invention;

In brief, the production process according to the invention comprises a phase of production of either a thin film or a macroscopic body, nanostructured along a vertical axis by means of production elements including means for spraying liquid micro-jets, such as inkjet print systems. According to another feature of the invention, such a production phase is planned to be actuated in parallel by means of matrices of these production elements.

Inkjet printing technology, exceedingly versatile, and which is the same technology adopted in several home printers, is slowly being extended to a number of production areas, such as, for instance, the field of electronics and nanotechnologies, to arrive to digital printing of ceramic tiles.

Printers apt to produce plastic moulds in three dimensions are increasingly being used by architects, allowing to obtain in a short time the same result which previously required days of work; the same type of set-up will be shortly made available to retail customers, being able to produce bulk bodies of whatsoever kind by rapid prototyping. New inks are available and already being placed on the market; they are constituted of polymers able to carry an electrical current; insulating and semi-conducting polymers; polymers suitable as waveguides in photonics or as optical lenses; solutions containing metallic nanoparticles for fabricating micrometer-sized antennas, etc.

According to the present invention, it is envisaged to use such technology together with magnetic materials for permanent magnets, by using inks containing solute magnetic nanoparticles, possibly functionalised, to feed a print head preferably provided with two nozzles able to independently spray an ink, or solution, for the hard phase and an ink, or solution, for the soft phase. The print head sprays the solution on a substrate or on a growth surface. After evaporation of a solvent of the ink where nanoparticles are dissolved, the latter aggregate to form the continuous surface of a magnetic material. If the nanoparticle surface is functionalised with a suitable ligand, a specific bonding between nanoparticles having different nature becomes possible: for instance, coating a Nd₂Fe₁₄B nanoparticle with a first ligand (a-type) and a Fe nanoparticle with a second ligand (b-type), as it will be clarified in the following with reference to FIGS. 2 and 3. These ligands (a, b) can be selected in such a way that they can originate a specific chemical reaction not allowing for the homologous bond (neither a with a, nor b with b) but allowing for heterologous bonding only; when nanoparticles of any phase (e.g., hard) are sprayed or ejected from the micro-jet head nozzle on the nanoparticles of the other phase (e.g., soft), they bound together with an energy determined by the nature of a-b chemical bonding. A possible example can be provided by the (covalent) bonding occurring between antigen and antibody, extremely specific in its action, and which can be obtained as a consequence of nanoparticle functionalisation by means of commercial products existing either in the form of aqueous solution or as powders.

The ligands are planned to be selected in order to determine a bonding energy such as to mechanically sustain the nanostructure even on a macroscopic scale, with a cohesive force larger of that of a compacted powder (so called “crude” or “green”).

An exemplary embodiment of the process according to the invention is now described with reference to FIGS. 1 to 5.

In FIG. 1, it is shown a first step of functionalisation of substrate 11 through a first ligand, indicated by the letter a in the figure. A carbonic (or more generally organic) phase connecting the first ligand a to substrate 11 is indicated as 18. Such a carbonic phase is also present for all additional ligands described in the following.

In the second step (hard phase deposition), shown in FIG. 2, a first solution containing hard-phase magnetic nanoparticles (12) is deposited on substrate 11 by means of a micro-jet (ink jet) head not shown in the figure. These hard-phase magnetic nanoparticles 12 can have, for instance, composition Nd₂Fe₁₄B. The solvent of solution can be, for instance, a mixture of ethanol and water, or hexane, or anisole, or other standard solvents used for inkjet printers.

Hard-phase magnetic nanoparticles 12 have, in this example, a diameter of about 10 nm and are functionalised by a second ligand b. The high magnetic anisotropy typical of hard-phase magnetic nanoparticles guarantees that they behave ferromagnetically at room temperature and up to at least 100° C.

As it can be observed, substrate 11 turns out to be coated by a layer 13 generated by the bonding of the first ligand a with the second ligand b. Therefore, hard-phase nanoparticles 12 give rise to a heterologous chemical bonding which takes place in layer 13, and their surface distribution will be determined by the shift of chemical equilibrium between ligand a fixed to substrate and ligand b present in the solution, which is bound to nanoparticles 12 on one side, and to the species ab generated by covalent bonding on the other side.

It is possible that the choice of size distribution of hard-phase nanoparticles 12 in solution will be made looking for a monodisperse system, i.e. a dispersion of particles having substantially homogeneous size, in order to optimise the homogeneity and smoothness of the layers.

Subsequently, as shown in FIG. 3, the soft-phase deposition step is performed; in this step, in a second print-head run a second nozzle sprays a different solution containing magnetic nanoparticles of a soft magnetic material 14 dispersed in a solvent on the material obtained in the preceding step, i.e., the layer 12 of hard nanoparticles functionalized by the second ligand b. In the embodiment shown, the diameter of these nanoparticles of a soft magnetic material 14 is of 120 nm, their surface being functionalised, similar to substrate 11, by the first ligand a. The larger size of soft material nanoparticles 14 guarantees their ferromagnetic behaviour at room temperature and up to at least 100° C. These particles of a soft magnetic material 14 precipitate, owing to their larger mass, to cover the previous layer of hard-phase nanoparticles 12, specifically bonding to them and generating a further layer 13 created by bonding of the first ligand a with the second ligand b.

The choice of size distribution of soft-phase nanoparticles 14 will possibly involve a polydisperse system, in order to increase the coating density by effect of the presence of spheres able to fill the smallest interstices.

The above described deposition steps are repeated several times, to finally result in a sheet, or film, of nanostructured material 15, which can be observed in FIG. 4, comprised of a set of hard-phase nanoparticulate layers 12 intercalated along a vertical axis Z by a set of soft-phase nanoparticulate layers 14, to finally reach a width comparable to that of a tin foil, i.e., sufficiently high to be handled by an automatic manipulator avoiding breakdown of the sheet of nanostructured multilayered material 15, before any further sintering step devised to increase higher stiffness to such sheet of nanostructured multilayered material 15. As an example, a preferred thickness of a film of nanostructured material 15 with the above mentioned mechanical properties is about 50 μm.

Subsequently, the sheet of nanostructured multilayered material 15 is assembled in stack together with other sheets 15, after carefully removing their substrates through a detaching action of chemical nature (i.e., using a surfactant) or mechanical nature (i.e., using a blade); the stacks of sheets of nanostructured layers can be assembled as a tablet, a form typically exploited for the commercialisation of many permanent magnetic materials; generally speaking, the interface between any sheet of nanostructured material 15 and the adjacent one is not an obstacle for dipolar coupling, making similar to a super-lattice, from the viewpoint of magnetic properties, the macroscopic magnet produced through the process according to the invention.

Therefore, the sheets, or foils, of nanostructured multilayered material 15 are assembled in a stack in order to obtain a macroscopic body comprised of a stalk of sheets 15 with a total thickness, for instance, of the order of 1 cm. With 50 μm thick films, as previously pointed out, this amounts to using 200 sheets of nanostructured multilayered material 15. Such a macroscopically assembled body is then submitted to thermal treatment by hot uniaxial pressing in order to allow for: thermolysis of the carbonic phase 18 connecting each nanoparticle 12 or 14 to the respective ligand a or b; thermolysis of the same ligand; filling-up of porosity; and an increase of theoretical density.

A detail of the effects of thermolysis process id shown in FIG. 5. In this figure, substrate 11′ represents a mechanical holder resistant to the above mentioned thermal treatment, for instance a steel sheet. The maximum temperatures reached during this phase (500÷600° C.) cannot be as high as those typical of a sintering process (800÷1000° C.) to avoid the degradation of the crystal lattice of the hard phase constituted by the hard magnetic nanoparticles 12. Simultaneously to the thermolysis step, a static magnetic field is applied with the aim of magnetizing the material. Such a process can be performed both on the material in the form of a thin film, and on the macroscopic body.

As mentioned, the described deposition process, according to a further feature of the invention, allows to use the printing heads in parallel in order to realize the deposition of the magnets elements. An illustrative diagram is shown in FIG. 6 relative to a deposition system 50 used to apply the procedure above described. Such a deposition system 50 comprises multiple rails 31 aligned in parallel above which are mounted moving tools used to spray liquid micro-jets, that is inkjet printing heads 30. Each set of rail 31 and printing head 30 may substantially correspond to the rail and printing head of an inkjet printer, whose mechanical layout and electronic control both in the movement and spraying phases are known. As shown in FIG. 6, the heads 30 may be operated as to print for example over circular regions 16 of material 15, repeating the steps of the procedure described referring to FIGS. 1-5, in particular the operations of spraying the hard and soft phase solutions, many times in parallel, to produce large amounts of macroscopic permanent magnets, of desired shape, having a lamellar-like nanostructure. The substrate 11 may be movable, for example along a direction perpendicular to the rails 31, in analogy with the scrolling mechanism of a paper sheet below a printing head of an inkjet printer, or also bidirectionally, depending on the requested positioning strategies.

In the example given by the circular regions 16 sheets for cylindrical permanent magnets are therefore originated. It must be noted that, in this regard, producing a permanent magnet with cylindrical shape, having 10 cm in height and 20 cm² base surface, with a single printing head featuring point-to-point control approximately 0.8 millions transits are needed of printing head 30 over a specific circular region 16. Considering a mean deposition time, limited by the maximum control frequency of the piezoelectric nozzle, leading to 10 s per sheet, this corresponds to a total deposition time of 185 days. By using a parallel architecture as that shown in FIG. 6 one can obtain instead a reduction of the deposition time. According to a variant embodiment, it is possible to place arrays of rails 31 to compose a 10×10 matrix of printing heads, for example by placing multiple heads on every rail, leading therefore to a system able to operate in parallel to the realization of 100 cylinders and exploiting to use 100 matrices of this kind it is possible to complete the production steps in only 3 seconds either of the laminates or of the sheets used to compose a 1-cm-thick cylinder above described.

According to a further aspect of the proposed process, it is allowed to gradually variate the composition of the nanostructured laminate, inserting a greater amount of hard phase nanoparticles, in particular a greater amount with respect to the standard composition adopted during the production with an additional layer used to increase the coercivity, either with one or more transits of the printing head or performing a deposition of the hard phase functionalized with the complimentary phase, for example, referring to the executive example given in FIGS. 1-5, functionalized with ligand a, resulting in a selective bond with the previous hard phase layer, which is on the contrary functionalized with ligand b. The hard phase enrichment to the expenses of the soft phase has the aim of inducing in the material a higher coercivity and hardly driven with an external magnetic field. Since the demagnetizing field, depending on the geometry of the magnet, has a maximum in correspondence with the surfaces featuring the maximum magnetic charge density with inward or outward magnetization, a possible method to reduce the tendency to self demagnetization of the superficial regions either of the single film or of the multilayered macroscopic aggregate consists in introducing regions with increased coercivity where needed, tuning with extremely refined control the material composition. Such a variant is furtherly advantageous with respect to other known techniques, because, at the present status, the production technologies do not allow to alter locally the magnetic properties of the material, unless one operates manually during the powders mixing phase prior to sintering.

Therefore, the procedure and deposition system here described show multiple advantages over existing methodologies.

The procedure according to the invention appears advantageous with respect to the principal methodologies which are used for the production of permanent magnets with biphasic materials, constituted by a hard ferromagnetic phase containing rare earths and a soft ferromagnetic phase based on Fe, Co or Ni, classified as powder metallurgy processes, allowing to develop a microcrystalline structure of biphasic alloys allowing either to reach or approach the theoretical characteristics that have been indicated by literature papers.

A further advantage of the procedure, according to the invention, is given by the economy of precious rare earths, which in classical processes must be introduced in much more sized volumes in order to result in an effective interaction, either based on exchange or on dipolar coupling.

The procedure and systems according to the invention therefore allow advantageously a complete control over the multilayered nanostructured biphasic material that permits to realize different products featuring extremely high performances.

The use of means to spray liquid micro-jets such as those employed on board of inkjet printers allows a complete control over the bidimensional coverage of the area of the magnet in production; by controlling the two nozzles separately it is possible to spray the inks, or the solutions, corresponding to both hard and soft phases of the composite; the absolute chemical specificity of the ligands chosen to functionalize the nanoparticles allows to realize in practice the same ideal order chosen for the super-lattice.

Such precise control at the nanoscale of the procedure according to the invention allows to reduce up to theoretical values the volume fraction of rare-earth-based alloys.

Of course, without obtaining the principle of the invention, details of production and embodiments may be widely varied with regard to what is described and illustrated, without thereby departing from the scope of the invention. The process according to the invention is applicable to the production of extremely high energy product permanent magnets, for the fabrication of dc current motors with extremely high energy efficiency. For example an ideal application is the fabrication of household appliances, where very small energy consumption and high rotation speeds are required to satisfy the market demand, featuring stringent limits from the point of view of energy savings and sustainability. An alternative application is represented by dc motors for the automotive segment, characterized by a high specific power and reduced hindrance.

In a preferred embodiment, as described, the printing heads are equipped with at least two nozzles, and therefore with two corresponding micro-chambers used to pressurize some amounts of hard phase solution and soft phase solution respectively by means of the respective actuators either piezoelectric or thermal to spray the solution towards the external atmosphere, depending on the inkjet printing technology, well known per se. It is possible nevertheless to employ one single nozzle to spray both the hard phase magnetic nanoparticles solution and the soft phase solution, eventually disposing a cleaning cycle for the printing head.

1. Process for the production of permanent magnets, comprising the operation of depositing nanostructured alloys of magnetic materials in the form of multilayered nanostructured materials, said operation of depositing comprised of depositing a first series of stacked layers of a hard ferromagnetic phase, intercalating said series of stacked layers with a second series of layers of a soft ferromagnetic phase, characterized in that said operation of depositing a first series of stacked hard ferromagnetic layers, intercalating said series of stacked layers with a second series of layers of a soft ferromagnetic phase including:
providing a hard ferromagnetic nanoparticle solution and/or a soft ferromagnetic nanoparticle solution,
feeding said magnetic nanoparticle solution to means for spraying liquid micro-jets,
spraying said nanoparticle solution of a hard ferromagnetic nanoparticle solution and/or a soft ferromagnetic nanoparticle solution.

2. Process according to claim 1, characterized in that said means for spraying liquid micro-jets comprise inkjet printing heads.

3. Process according to claim 1, characterized in that comprises the using means to spray liquid micro-jets including at least two nozzles and feeding to one of the nozzles a first solution containing the hard ferromagnetic phase nanoparticles and to another of the nozzles a second solution containing the soft ferromagnetic phase nanoparticles.

4. Process according to claim 1 characterized in that comprises the step of functionalizing with a respective ligand (a, b) said nanoparticles of hard ferromagnetic phase and/or soft ferromagnetic phase.

5. Process according to claim 4, characterized in that allows to select said respective ligands (a, b) to originate a chemical reaction apt to allow only a heterologous bond between said ligands (a, b).

6. Process according to claim 1, characterized in that comprises:
functionalizing a substrate with a first ligand (a);
spraying using said means for spraying liquid micro-jets over said substrate a first solution containing hard ferromagnetic phase nanoparticles functionalized with a second ligand (b) apt to establish an heterologous with said substrate to obtain a hard ferromagnetic phase layer;
spraying with said means for spraying liquid micro-jets a second solution containing soft ferromagnetic phase nanoparticles, functionalized with said first ligand (a) to obtain a soft ferromagnetic phase layer;
repeating alternatively said steps of spraying a first solution and a second solution to obtain said nanostructured multilayered material comprising said first series of stacked layers of a hard ferromagnetic phase intercalated by a second series of soft ferromagnetic phase layers.

7. Process according to claim 1, characterized in that comprises assembling a plurality of sheets of said multilayered nanostructured material in a macroscopic assembly and of submitting said macroscopic assembly to a thermal treatment by hot uniaxial pressing.

8. Process according to claim 7, characterized in that comprises applying, during said thermal treatment by hot uniaxial pressing, a magnetostatic field, in order to magnetize the material.

9. Process according to claim 2, characterized in that comprises employing a plurality of inkjet printing heads operating along parallel axes for spraying said solution of hard ferromagnetic phase nanoparticles and/or soft ferromagnetic phase nanoparticles.

10. Process according to claim 9, characterized in that said operation of employing a plurality of inkjet printing heads operating along parallel axes comprises ordering said plurality of printing heads on a matrix disposition scheme.

11. Process according to claim 2, characterized in that said operation of deposition comprises varying the composition of said first series of stacked layers of hard ferromagnetic phase and/or said second series of stacked layers of soft ferromagnetic phase with respect to the deposition vertical axis (Z).

12. Process according to claim 11, characterized in that said step of operation of varying the composition comprises inserting a greater amount of hard ferromagnetic phase nanoparticles, in particular a greater amount with respect to the standard composition which is adopted during production by means of the deposition of a supplementary layer for increasing the coercivity.

13. Process according to claim 11, characterized in that said step of the operation of varying the composition comprises spraying a solution of hard ferromagnetic phase nanoparticles functionalized with the first ligand (a) in order to obtain a selective bond with a previous layer of hard ferromagnetic phase functionalized with ligand (b).

14. Process according to claim 1, characterized in that said nanostructured alloys comprise a fraction smaller than 10% of stoichiometric rare-earth-based compound.

15. Process according to claim 1, characterized in that the dimensional distribution of the hard ferromagnetic phase nanoparticle solution (12) is a monodispersion.

16. Process according to claim 1, characterized in that the dimensional distribution of the soft ferromagnetic phase nanoparticle solution is a monodispersion.

17. System for the production of permanent magnets by means of the deposition of nanostructured alloys in the form of multilayered nanostructured material, configured to deposit a first series of stacked layers of hard ferromagnetic phase intercalated by a second series of soft ferromagnetic phase layers characterized in that said system comprises means for spraying liquid micro jets and means for feeding a ferromagnetic nanoparticle solution of said hard magnetic phase and/or said soft magnetic phase to said means for spraying liquid micro-jets.

18. System according to claim 17, characterized that said means for spraying liquid micro-jets comprise inkjet printing heads.

19. System according to claim 17, characterized in that said means for spraying liquid micro-jets comprise at least two nozzles for spraying separately said first solution containing hard magnetic phase nanoparticles and said second solution containing soft magnetic phase nanoparticles.

20. System according to claim 17, characterized in that is configured for:
functionalizing a substrate with a first ligand (a);
spraying with said means for spraying liquid micro-jets over said substrate a first solution containing hard phase nanoparticles functionalized with a second ligand (b) apt to establish an heterologous chemical bond with said substrate to obtain a hard magnetic layer;
spraying with said means for spraying liquid micro-jets over said substrate a second solution containing soft phase nanoparticles functionalized with said first ligand (a) to obtain a soft magnetic layer;
repeating said steps of spraying a first solution and a second solution to obtain said nanostructured multilayered material comprising said first series of stacked layers of a hard magnetic phase intercalated by a second soft magnetic layer.

21. System according to claim 17, characterized in that is configured for assembling in a stacked layout a plurality of sheets of said nanostructured multilayered material resulting in a macroscopic assembly and submitting said macroscopic assembly to a thermal treatment by uniaxial hot pressing.

22. System according to claim 1, characterized in that comprises a plurality of inkjet printing heads arranged to operate along orthogonal axes for spraying said solution for depositing said first series of layers and/or said second series of layers.

23. System as in claim 22, characterized in that said plurality of inkjet printing heads operating along orthogonal axes operate in a matrix layout.

24. Permanent magnet comprising a first series of stacked layers of hard magnetic phase material, intercalated to said first series of stacked layers a second series of soft magnetic phase, characterized in that it is produced according to the process according claim 1.

25. Permanent magnet according to claim 24, characterized in that it is a thin film.
